(19) United States
(12) Patent Application Publication
(10) Pub. No.: US 2026/0049582 A1
(43) Pub. Date: Feb. 19, 2026

(54) METHOD FOR OPERATING AN INTERNAL COMBUSTION ENGINE AND INTERNAL COMBUSTION ENGINE

(71) Applicant: Dr. Ing. h.c. F. Porsche Aktiengesellschaft, Stuttgart (DE)

(72) Inventor: Holger Wöhr, Weissach (DE)

(73) Assignee: Dr. Ing. h.c. F. Porsche Aktiengesellschaft, Stuttgart (DE)

(21) Appl. No.: 19/302,135

(22) Filed: Aug. 18, 2025

(30) Foreign Application Priority Data
Aug. 19, 2024 (DE) 102024123561.6

(51) Int. Cl. F02D 41/00; F02M 25/028; F02P 5/15

(52) U.S. Cl. CPC F02D 41/0025; F02M 25/028; F02P 5/1502

(57) ABSTRACT

A method for operating an internal combustion engine. In order to abruptly reduce a torque of the internal combustion engine and/or to provide a low torque by the internal combustion engine, an ignition angle adjustment to later is carried out, wherein water is injected into an intake tract of the internal combustion engine by a water injection system. A limit ignition angle for the ignition angle adjustment is determined based on an amount of water injected by the water injection system.

### CROSS REFERENCE TO RELATED APPLICATION

This application claims priority to German Patent Application No. 10 2024 123 561.6, filed Aug. 19, 2024, the content of such application being incorporated by reference herein in its entirety.

### FIELD OF THE INVENTION

The present invention relates to a method for operating an internal combustion engine, wherein, in order to abruptly reduce a torque of the internal combustion engine and/or to provide a low torque by the internal combustion engine, an ignition angle adjustment to later is carried out. The present invention further relates to an internal combustion engine having a control unit configured so as to carry out such a method.

### BACKGROUND OF THE INVENTION

An abrupt reduction of a torque of the internal combustion engine allows, for example, for particularly dynamic shifting operations of a transmission coupled to the internal combustion engine or a particularly effective overrun fuel cut-off.

In particular, a low torque is understood to mean a torque that cannot be realized solely by adjusting a cylinder charge of the internal combustion engine.

For abruptly reducing a torque of an internal combustion engine, it is known from DE 10 2020 116 456 A1, which is incorporated by reference herein, to carry out an ignition angle adjustment to later during a gear shift.

### SUMMARY OF THE INVENTION

The present invention addresses the problem of enabling the realization of a dynamically driveable motor vehicle with relatively low fuel consumption.

In the method according to aspects of the invention for operating an internal combustion engine, in order to enable an abrupt reduction of a torque of the internal combustion engine and/or to provide a particularly low torque by the internal combustion engine, an ignition angle adjustment to later is carried out, wherein the ignition angle is adjusted maximally to later up to a limit ignition angle. The limit ignition angle here indicates a latest possible ignition angle for which misfires can be reliably excluded under the respective operating parameters. Preferably, in order to enable a particularly abrupt reduction in torque, an ignition angle adjustment to the limit ignition angle is carried out. This allows for particularly dynamic shifting operations as well as particularly effective overrun fuel cut-off.

In the method according to aspects of the invention for operating an internal combustion engine, in order to reduce emissions, reduce fuel consumption and/or increase power, water is further injected into an intake tract of the internal combustion engine by means of a water injection system which is configured in a manner known per se.

Due to the fact that, by injecting water, the combustion process in the internal combustion engine is “delayed,” in the method according to aspects of the invention for operating an internal combustion engine, in order to avoid misfires, the limit ignition angle for the ignition angle adjustment is determined or adjusted/corrected based on an amount of water injected by the water injection system, wherein the determined limit ignition angle is earlier the greater the amount of water injected by the water injection system.

The method according to aspects of the invention thus enables the realization of a dynamically driveable motor vehicle with relatively low fuel consumption.

Because the air pressure decreases with increasing geographic elevation, in order to reliably avoid misfires, the limit ignition angle for ignition angle adjustment is preferably additionally determined based on a geographic elevation.

The internal combustion engine according to aspects of the invention comprises a water injection system configured in a manner known per se. The water injection system comprises at least one injection nozzle configured so as to inject water into an intake tract of the internal combustion engine, preferably into a so-called suction tube of the internal combustion engine. Preferably, the water injection system comprises a number of injection nozzles corresponding to the number of cylinders of the internal combustion engine, each configured so as to inject water into the suction tube of one of the cylinders. The water injection system typically comprises a pump configured so as to convey water from a water tank via water lines to the at least one injection nozzle.

The internal combustion engine according to aspects of the invention further comprises a control unit configured so as to carry out a previously described method according to the present invention for operating an internal combustion engine. Preferably, the control unit is realized by suitable programming of an engine control unit of the internal combustion engine. The engine control unit may comprise a conventional computer having a processor, memory having software loaded thereon, controller, etc.

By carrying out the method according to aspects of the invention for operating an internal combustion engine, for the aforementioned reasons, the control unit enables the realization of a dynamically driveable motor vehicle with relatively low fuel consumption.

### BRIEF DESCRIPTION OF THE DRAWING FIGURE

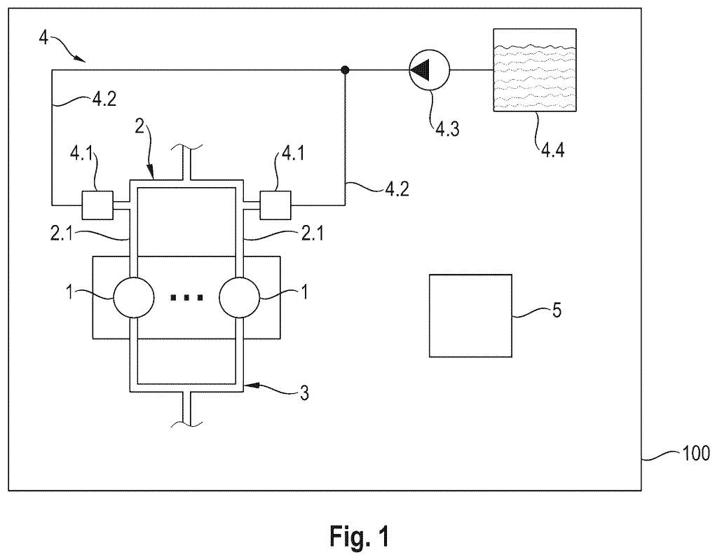

An example embodiment of the present invention is described below on the basis of the attached FIG. 1, which shows a schematic diagram of an internal combustion engine according to aspects of the invention.

### DETAILED DESCRIPTION OF THE INVENTION

FIG. 1 shows an internal combustion engine 100 according to aspects of the invention, having a plurality of cylinders 1, an intake tract 2 and an exhaust tract 3, wherein the plurality of cylinders 1 are each connected to the intake tract 2 for supplying combustion air and to the exhaust tract 3 for dissipation of exhaust gas.

The internal combustion engine 100 further comprises a water injection system 4 having a number of injection nozzles 4.1 corresponding to the number of cylinders 1, each configured so as to inject water provided via a water line 4.2 into the intake tract 2, specifically into a suction tube 2.1 associated with the cylinder 1.

The water injection system 3 further comprises a pump 4.3 and a water tank 4.4, wherein the pump 4.3 is configured so as to supply water from the water tank 4.4 to the injection nozzles 4.1 via the water lines 4.2 at a defined water pressure.

The internal combustion engine 100 further comprises a control unit 5 configured so as to inject a defined amount of water into the intake tract 2 via the water injection system 3. The amount of water may be measured by a sensor or by tracking a duration of operation of pump 4.3, for example.

The control unit 5 is further configured so as to determine a current limit ignition angle based on the amount of water currently injected by the water injection system 3, as well as based on provided information about a current geographic elevation, wherein the limit ignition angle indicates a latest possible ignition angle for which misfires can be safely excluded under the present operating parameters. The geographic elevation may be monitored by GPS, a barometric sensor, altimeter, or any other elevation monitoring means known in the art.

The control unit 5 is further configured so as to carry out an ignition angle adjustment to later as needed in order to abruptly reduce a torque of the internal combustion engine 100 and/or to provide a particularly low (or lower) torque by the internal combustion engine 100, wherein the ignition angle adjustment is always limited by the currently determined limit ignition angle. The torque may be reduced either to or by a pre-determined value.

List of reference numerals

| | |
|---|---|
| 100 | Internal combustion engine |
| 1 | Cylinder |
| 2 | Intake tract |
| 2.1 | Suction tubes |
| 3 | Exhaust tract |
| 4 | Water injection system |
| 4.1 | Injection nozzles |
| 4.2 | Water lines |
| 4.3 | Pump |
| 4.4 | Water tank |
| 5 | Control unit |

What is claimed is:

1. A method for operating an internal combustion engine, wherein, in order to abruptly reduce a torque of the internal combustion engine and/or to cause the internal combustion engine to operate at a lower torque, an ignition angle adjustment is later carried out, said method comprising the steps of:
injecting water into an intake tract of the internal combustion engine using a water injection system; and
determining a limit ignition angle for the ignition angle adjustment based on an amount of water injected by the water injection system.

2. The method according to claim 1, wherein the limit ignition angle for the ignition angle adjustment is additionally determined based on a geographic elevation.

3. The method according to claim 1, further comprising adjusting the limit ignition angle to the determined limit ignition angle in order to abruptly reduce the torque of the internal combustion engine and/or to cause the internal combustion engine to operate at the lower torque.

4. An internal combustion engine comprising:
a water injection system; and
a control unit configured to (i) inject water into an intake tract of the internal combustion engine using a water injection system, and (ii) determine a limit ignition angle for the ignition angle adjustment based on an amount of water injected by the water injection system.

5. The internal combustion engine of claim 4, wherein the limit ignition angle for the ignition angle adjustment is additionally determined based on a geographic elevation.
